(19) United States
(12) Patent Application Publication
(10) Pub. No.: US 2009/0023626 A1
(43) Pub. Date: Jan. 22, 2009

(54) Natural fibers wash and rinse and method of using same

(76) Inventor: Anne Carner Blangiforti, Califon, NJ (US)

Correspondence Address: THOMAS A. BECK, 15 ALAMERA PLACE, MOUNT VERNON, NY, 10552, US

(21) Appl. No.: 11/893,628

(22) Filed: Jul. 16, 2007

(51) Int. Cl. D06M 23/00; C11D 3/60

(52) U.S. Cl. 510/515

(57) ABSTRACT

A combination of two separate compositions used for cleaning natural fibers and fabrics made therefrom and the method of using same. The first composition provides for low temperature washing of the fibers and contains two different non-ionic surfactants and an anionic surfactant in the ratio of about 3:1 and 1:3 respectively. The composition for the rinse cycle is between about 1 and 3 percent by weight of at least one non-ionic surfactant and between about 15 and 25 percent by weight of a cationic surfactant.

### FIELD OF THE INVENTION

Aqueous surfactant-containing composition and method for using same for the cleaning and conditioning of natural fibers and any items made therefrom.

### DESCRIPTION OF THE PRIOR ART

The present invention relates to compositions and the method using same for the cleaning, i.e., washing and rinsing, treatment of natural fibers. The expression “Natural fibers” as defined for the purposes of the instant invention shall be a general term for fibers derived from natural substances such as cellulose, proteins and/or minerals, and includes fibers that were not created by people, such as cotton, linen, wools including cashmere, merino and Alpaca, bison, qivuit, mohair and silk.

Natural fibers are important in the production of fine items such as garments including sweaters, scarfs, as well as blankets, rugs etc. In appropriate instances, the natural fibers need to be cleaned by removing the dirt and natural oils from the specific animal the fiber is derived, before they are useful for making such item. There is also a need to clean the aforementioned finished products from time to time as they become soiled with use. Common household and industrial detergents are not suitable for initial scouring of such fibers as these cleaning means are deemed to harsh and will upset the natural fiber structure and end-feel causing unwanted outcomes such as shrinkage, difficult processing, poor handling, carding and the like.

The present invention differs from the prior art in that superior cleaning performance is attained at lower operational temperatures with a unique combination of nonionic and anionic surfactants in combination with a mild builder system. The entire combination of formula ingredients is also a single phase and stable solution.

The claims of this invention are for initial scouring of fibers as they are processed for final conversion into woven materials for garments and the like.

The present invention provides for an environmental sound composition designed to effectively remove unwanted soil contaminates and lanolin type waxes from the fiber at lower operating temperatures than current products on the market (such as those containing nonyl phenol) and imparting improved processing and handling characteristics to the fiber.

### SUMMARY OF THE INVENTION

The present invention comprises a combination of separate compositions and the method of using same. The first composition provides for low temperature cleaning (washing) of the fibers. The second composition in the sequence of steps rinses the fibers and imparts conditioning thereto which helps to improve fiber processing throughput and the end-quality of the fibers.

More specifically, the present invention provides a composition for the treatment of natural fibers, which composition, along with various adjuvants contains non-ionic surfactants and anionic surfactants in the ratio of about 3:1 and 1:3 respectively; there being at least two nonionic surfactants having different molecular structures in said composition, each having a hydrophilic/lipophilic balance (HLB) value between about 0 and 20, there being a difference in the HLB values of the nonionic surfactants in said composition of at least 2. The nonionic surfactants for the wash cycle are present in the ratio of about 1:2.

The composition for the rinse cycle of the method is between about 1 and 3 percent by weight of at least one non-ionic surfactant and between about 15 and 25 percent by weight of a cationic surfactant as set forth in greater detail below.

An object of the present invention is to provide an environmentally safe composition that optimizes the fiber scour operations to maximize cleaning effectiveness at low temperatures.

An important object of the invention is also to impart fiber conditioning for ease of handling and processing. This includes Alpaca fibre and Merino Wool fibre but this invention is not limited to these fibers only.

Furthermore another object is to provide the above benefits with the use of safe and environmental sensitive formulae ingredients.

Another object is to provide for energy savings as operational bath temperatures can be reduced and yet provide the same cleaning as other products used at higher temperatures.

### DESCRIPTION OF THE DRAWINGS

FIG. 1 is a graph showing calorimetric test results comparing samples of the present invention with prior art controls.

### DESCRIPTION OF THE PREFERRED EMBODIMENT

The present invention is based upon the use of two separate compositions, the first of which is used as the wash and the second of which is used as the rinse. The compositions rely on surfactants, present in specific amounts and ratios of hydrophilic to lipophilic moieties in order to provide the unexpectedly effective washing and rinsing results.

Surfactants as used herein refers to any substance that when dissolved in an aqueous solution reduces its surface tension between it and another liquid. Further it is a surface-active agent which increases the emulsifying, foaming, dispersing, spreading and wetting properties of a product. As a surface-active agent, a surfactant is usually an organic compound whose molecules contain a hydrophilic group at one end and a lipophilic group at the other. It is well known in the art that there are three types of surfactants: anionic, cationic and nonionic.

An anionic surfactant is a surfactant derived from an alkyl hydrocarbon and usually a sodium salt, in which detergent (cleaning) and other properties depend in part on the negatively charged anion of the molecule; hence the name “anionic.”

A cationic surfactant is a surfactant possessing a molecule that can dissociate to yield a surfactant ion whose polar group is positively charged; hence the name “cationic.”

A nonionic surfactant is a surfactant possessing a molecule whose polar group is not electrically charged. It has a hydrocarbon tail and a polar head whose oxygen atoms attract water molecules and make the head water soluble. It bears no ionic charge; hence the name “nonionic.”

The “wash” composition of the present invention is based upon the use therein of a ratio of nonionic to anionic surfactants; and is further based upon a specified ratio to two different nonionic surfactants with identified HLB (Hydrophillic/Lipophilic Balance). The HLB(value) is an arbitrary scale from 0 to 40 depicting the Hydrophilic/Lipophilic Balance of a surfactant. Surfactant products with a low HLB on the overall 0 to 40 scale are more oil soluble. A high HLB represents good water solubility. Note that HLB is a numerically calculated number based on the surfactant's molecular structure.

It has been determined that for the purposes of the present invention, nonionic surfactants having HLB values in excess of 20 do not provide the beneficial results as do those surfactants having values between 0 and 20. A preferred range is between about 5 and 16 and the most preferred range is between about 8 and 14. Thus in accordance with the present invention, there are at least two different nonionic surfactants in terms of molecular structure in said composition each having a hydrophilic/lipophilic balance (HLB) value between about 0 and 20, with the additional proviso that there is a difference in the HLB values of the nonionic surfactants in wash and rinse compositions of at least 2.

The ratio of total nonionic surfactant to anionic surfactant is between about 3/1 to about ⅓. Further, the ratio of nonionic surfactants in every case is held at ½ Low HLB to high HLB.

The low HLB nonionic surfactants used in accordance with the present invention are chosen from those within the range of HLB of about 5-12. Any surfactant within this range is acceptable. One example of such a surfactant is Tomadol 1-5 supplied by Tomah Chemicals.

The High HLB nonionic surfactants used in accordance with the present invention are chosen from the range of HLB 12-16. One example of such a surfactant is Tomadol 25-7 supplied by Tomah Chemicals.

As noted above, in the composition for the treatment of natural fibers, the first (low) nonionic surfactant in said composition has an HLB value in the range of between about 5 and 12 and the second (high) anionic surfactant in composition has an HLB value in the range of 12 to 16.

In a preferred embodiment of the composition of the present invention, the first nonionic surfactant has an HLB value in the range of between about 8 and 11 and the second anionic surfactant has an HLB value in the range of between about 13 to 14. In the event there is an overlap between the end of the low HLB range and the beginning of the HLB range, (e.g., 12) HLB values of nonionic surfactants used in the composition must differ by a value of at least 2.

The non-ionic surfactant is preferably a surfactant having the formula RO—(CH₂₋CH₂₋O)ₙ—H wherein R is a mixture of linear, even carbon number hydrocarbon chains ranging from C₁₂H₂₅ to C₁₆H₃₃ and n represents the number of repeating units and is a number from 1 to about 12. Also included are primary alkyl alcohols containing between about 12 and 16 carbon atoms condensed with about 2.5 to 16 moles of ethylene oxide and secondary alkyl alcohols containing between about 11 and 18 carbon atoms in a straight or branched chain configuration condensed with between about 5 to 30 moles of ethylene oxide.

Other specific examples of nonionic surfactants include primary alcohol ethoxylates (available under the Neodol tradename from Shell Co.), such as C₁₁ alkanol condensed with 9 moles of ethylene oxide (Neodol 1-9), C₁₂₋₁₃ alkanol condensed with 6.5 moles ethylene oxide (Neodol 23-6.5), C₁₂₋₁₃ alkanol with 9 moles of ethylene oxide (Neodol 23-9), C₁₂₋₁₅ alkanol condensed with 7 or 3 moles ethylene oxide (Neodol 25-7 or Neodol 25-3), C₁₄₋ₗ₅ alkanol condensed with 13 moles ethylene oxide (Neodol 45-13),

C₉₋₁₁ linear ethoxylated alcohol, averaging 2.5 moles of ethylene oxide per mole of alcohol (Neodol 91-2.5), and the like. Generally the trade names of these compounds identify in order, the alkyl link and then the amount of repeating ethoxy units.

As noted the suitable non-ionic surfactants in the wash sequence include ethylene oxide condensate products of secondary aliphatic alcohols containing 11 to 18 carbon atoms in a straight or branched chain configuration condensed with 5 to 30 moles of ethylene oxide. Examples of commercially available nonionic detergents of the foregoing type are C₁₁₋₁₅ secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type non-ionic surfactants, for example, Triton X-100, as well as amine oxides can also be used as a non-ionic surfactant in the present invention.

Other examples of linear primary alcohol ethoxylates are available under the Tomadol tradename such as, for example, Tomadol 1-7, a C₁₁ linear primary alcohol ethoxylate with 7 moles EO; Tomadol 25-7, a C₁₂-C₁₅ linear primary alcohol ethoxylate with 7 moles EO; Tomadol 45-7, a C₁₄-C₁₅ linear primary alcohol ethoxylate with 7 moles EO; and Tomadol 91-6, a C₉-C₁₁, linear alcohol ethoxylate with 6 moles EO.

Anionic surfactants are used in the present invention. Suitable anionic surfactants found useful in the present invention are selected from the group selected from linear or branch C₁₀₋₁₆ alkyl benzene sulfonates, C₉ to C₁₆ alkyl ethoxy sulfates having 2.5 to 16 moles ethylene oxide, C₉ to C₁₆ alkyl alcohol sulfates potassium ammonium salts of alcohol sulfates, sodium ammonium salts of alcohol sulfates and sulfonates, C₉ to C₁₆ alcohol phosphates and phosphonates, C₉ to C₁₆ alkyl sulfonates, C₉ to C₁₆ alkyl ethoxy sulfonates having 2.5 to 16 moles ethylene oxide, C3 to C6 alkylphenyl sulfonates, C₁₀₋₁₈ alkyl alkoxy carboxylates having 1 to 5 moles of ethylene oxide, and C₁₀₋₁₈ sarcosinates.

A specific example of such an anionic surfactant is Biosoft S130 supplied by Stepan Chemical Co.

Other compatible additives to provide an anti-static, buffered pH effect, etc. are added to the surfactants in the blend along with water to form the wash composition. Optional adjuvants that can beneficially added to the compositions are certain cleaning adjuvants which include, but are not limited to the following materials: enzymes such as protease, amylase, lipase, cellulase from Novozyme; optical brighteners such as Tinopal AMS-GX by Ciba specialty chemicals; anti-nucleation compounds such as phosphonates as in Dequest 2006 by Monsanto, and oxidants such as hydrogen peroxide.

The compositions of the present invention are clear, colorless liquids which show single phase stability over the range of operating storage temperatures of 25° C. to 40° C.

The second stage of the present invention is a post cleaning treatment, i.e. a rinse, which provides fiber conditioning and improved processing.

The composition used in the rinse portion of the method of the present invention (See Example C below) is a viscous liquid (70,000-140,000 cp) having a slightly cream color.

The rinse composition utilizes the nonionic surfactants set forth above and are hereby incorporated by reference herein. The range for the HLB of the rinse composition is between about 8 and about 14. A particularly useful ethoxylated alcohol employed in the present invention rinse composition is Tomadol 25-7. Other ethoxylated alcohols can also be used.

Another important constituent in the rinse composition of the present invention is a cationic surfactant.

Suitable cationic (detersive) surfactants suitable for use in the rinse phase composition of the present invention are those having one long-chain hydrocarbyl group. Examples of such cationic surfactants include the ammonium surfactants such as alkyldimethylammonium halogenides, and those surfactants having the formula:

[R²(OR³)]_{y}[R⁴(OR³)_{y}]₂ R⁵ N⁺X⁻

wherein R² is an alkyl or alkyl benzyl group having from about 8 to about 18 carbon atoms in the alkyl chain, each R³ is selected from the group consisting of —CH₂CH₂—, —CH₂CN(CH₃)—, —CH₂CH(CH₂OH)——, ——CH₂CH₂CH₂——, and mixtures thereof; each R⁴ is selected from the group consisting of C₁-C₄ alkyl, C₁-C₄ hydroxyalkyl, benzyl ring structures formed by joining the two R⁴ groups, —CH—CHOH—, CHOHCOR⁶CHOHCH₂OH wherein R⁶ is any hexose or hexose polymer having a molecular weight less than about 1000, and hydrogen when y is not 0: R⁵ is the same as R⁴ or is an alkyl chain wherein the total number of carbon atoms of R² plus R⁵ is not more than about 18; each y is from 0 to about 10 and the sum of the y values is from 0 to about 15: and X is any compatible anion.

Other cationic surfactants useful herein are also described in U.S. Pat. No. 4,228,044, Cambre, issued Oct. 14, 1980, incorporated herein by reference.

A particularly useful cationic surfactant in the rinse composition of the present invention is Accosoft 501 which is methylbis(tallowamidoethyl)-2-hydroxyethylammonium methyl sulfate since it is found to provide excellent stability and softening feel to treated fibers.

The wash cycle of the present invention is designed to optimize cleaning of the delicate fibers while protecting the fiber cuticle.

In general, the range of each of the wash and the rinse compositions (liquor) of the present invention used as added to wash or rinse water is between about 0.1% and about 0.8% by weight. The method used in a typical wash cycle comprises adding 0.5 oz of wash composition to between about 1 and about 2 gallons of water. The delicate fiber/fabric is placed in a garment bag and the bag with contents is placed in the wash solution and is fully submerged being careful not to abuse the fiber/fabric. The fiber/fabric are soaked for 3-5 minutes. For raw fiber, the soak time is up to 15 minutes and several wash cycles may have to be preformed on the fiber until the water remains clear. The bag with fiber/fabric is then removed and gently the solution is removed from the fiber/fabric by squeezing or other means.

The method used in a typical rinse cycle comprises adding 0.5 oz of wash composition to between about 1 and about 2 gallons of water and mixing same to obtain a uniform solution. The washed delicate fiber/fabric in the garment bag is placed in the rinse solution and is fully submerged to soak. The fiber/fabric are soaked for 3-5 minutes. optionally one may repeat the rinse cycle as often as necessary. The bag with fiber/fabric is then removed and gently the rinse solution is removed from the fiber/fabric by squeezing or other means and the item so washed and rinsed is placed on a drying rack away from direct heat or sun.

### Cleaning Test

To demonstrate the utility of this invention a wash cleaning test was conducted. An evaluation of wash conditions for scouring raw Alpaca fiber was developed. The results confirm that the compositions of Example A and Example B as set forth hereinafter provides enhanced cleaning performance relative to typical compositions used today.

The following compositions were prepared and swatches of Alpaca were washed at room temperature in accordance with the method set forth below:

### Example A

| Ingredient | Wt % |
|---|---|
| C₁₀ ethoxylated alcohol Tomadol 1-5 | 7 |
| C₁₂₋₁₅ ethoxylated alcohol Tomadol 25-7 | 15 |
| C₁₂ alkyl bezene sulfate* | 7 |
| Sodium Bicarbonate | 1 |
| Sodium Carbonate | 0.5 |
| Water soluble polymer | 0.5 |
| Fragrance | 0 |
| Water | 69 |
| Total | 100.0 |

7% of an alkyl C₁₀ with 5 moles and 15% of a C₁₂₋₁₅ with 7 moles EO.

### Example B

| Ingredient | Wt % |
|---|---|
| C₁₀ ethoxylated alcohol Tomadol 1-5 | 2.5 |
| C₁₀ ethoxylated alcohol Tomadol 25-7 | 5 |
| C₁₀₋₁₈ linear alkyl benzene sulfate* | 22 |
| Sodium Bicarbonate | 1 |
| Sodium Carbonate | 0.5 |
| Water soluble polymer** | 0.5 |
| Fragrance | 0 |
| Water | 68 |
| Total | 100.0 |

2.5% of an alkyl C₁₀ with 5 moles of EO and 5% of a C₁₂₋₁₅ with 7 moles EO.
*LABSBiosoft (38%)
**Alcosperse 408

Additional tests were run using as the first nonionic surfactants Tomadol 25-3 (C₁₂-C₁₅), Tomadol 23-3 (C₁₂-C₁₃) and Tomadol 45-2.25 (C₁₄-C₁₅), and as the second nonionic surfactant Tomadol 25-7 (C₁₂-C₁₅) Tomadol 25-9 (C₁₂-C₁₅) and Tomadol 25-12 (C₁₂-C₁₅. Similar results were obtained as those obtained with respect to Examples A and B.

A preferred embodiment of the composition of the rinse used in accordance with the present invention is set forth as follows:

### Example C

| Ingredient | Wt % |
|---|---|
| Ethoxylated Alcohol | 2 |
| Tomadol 25-7 (1.32%) | |
| Tomadol 1-5 (0.68%) | |
| with HLB 8-12 | |
| Accosoft 501*** (88%) | 22 |
| Sodium chloride | 0.05 |
| Fragrance | 0.03 |
| Water | 75.92 |
| Total | 100 |

***methylbis(tallowamidoethyl)-2-hydroxyethylammonium methyl sulfate

### Test Method

BYK Garner calorimeter was used to obtain LAB color values for the pre and post readings of the fiber. Fiber readings were taken by weighing seven grams of fiber and then matting this out onto an area of about 9 cm². The fiber sample was then pressed flat with a clean 3×3 Plexiglas plate. Five readings were taken and the average used in calculations. Delta E (ΔE) values were converted into % soil removal using standard methods.

%SR=[(ΔEₚᵣₑ−ΔEₚₒₛₜ)/ΔEₚᵣₑ]*100

Visual grading scores were also determined for the post wash samples. A ranking system of 1-6, 1=whitest to 6=darkest was employed.

Magnetic stir plates equipped with temperature control probes were used to control and maintain temperatures to within ±2°. A standardized precision scientific thermometer was used to record temperatures.

During washing the seven gram fiber sample was placed into 200 mL of water containing 0.49 grams of the test cleaning solution and gently stirred for 10 minutes. The fiber was then removed from the cleaning solution and allowed to rinse with gentle stirring for 5 minutes.

Cold tap water (15°) was used as the rinse water. The fiber was hand squeezed to remove excess water and then dried convectively in a warm oven. Samples were stored in plastic bags between post reading and visual inspection. All tests were done in duplicate with the average result compared.

### Test Evaluation

The final cleaned samples were evaluated first under visual grading scale. Samples were placed on a well lighted clean table with a white background. Each sample was compared to an unwashed fiber sample and a bleached-white fiber sample and scaled from 1=best clean to 6=worst cleaned. The results are shown below:

TEST SAMPLES AND VISUAL GRADING

| Test | Sample |
|---|---|
| 1 | Tergitol |
| 2 | Example A |
| 3 | Example B |
| 4 | Water Control |

Test #

| | 1 | 2 | 3 | 4 |
|---|---|---|---|---|
| Rep 1 | 4 | 1 | 2 | 6 |
| Rep 2 | 4 | 1 | 2 | 6 |

Alpaca samples within this test which showed the best visual results were washed with the compositions set forth in Examples A & B described above.

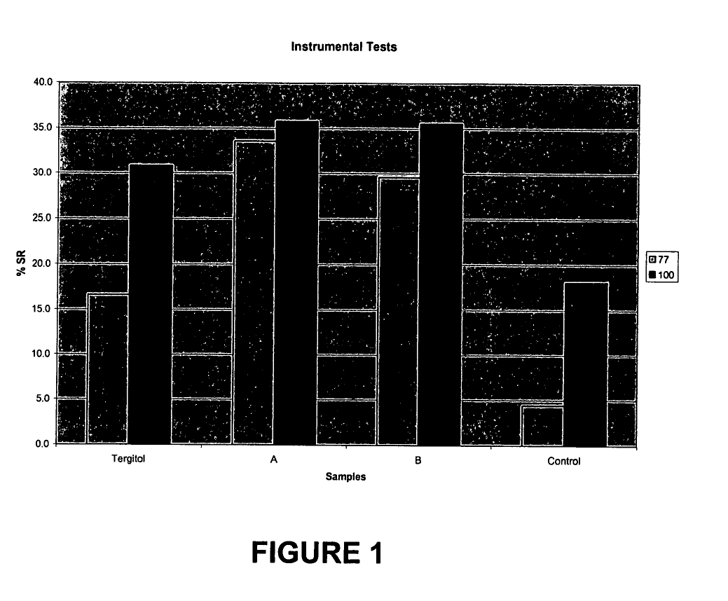

In further testing with instrumental calorimetric readings Alpaca samples washed with the compositions found in Examples A & B above, again show improved cleaning performance. Results are shown in the graph found in FIG. 1.

The best overall cleaning at both temperatures studied was found to be test formulas in Examples A & B. The lowest cleaning results were found for the water only control. The compare formula was based on 50% Tergitol and 50% tallow based soaps with average carbon chain length of 12.

To establish the efficiency of the composition and process of the present invention, the thermodynamics of the system of the present invention was evaluated with the following results.

### EXAMPLE

A 1000 liter wash tank requires 46 kwh to heat this volume of water from 25° C. to 60° C. In the prior art it is standard practice to run the wash process at that temperature. In comparison it requires only 17 kwh to heat the same volume of water from 25° C. to 40° C. This is a 63% reduction in energy usage for bath heating not to mention savings from maintaining the water at the higher temperatures which is another source for savings.

While there have been shown and described and pointed out fundamental novel features of the invention as applied to currently preferred embodiments thereof, it will be understood that various omissions and substitutions and changes in the form and details of the composition and method illustrated, and in their operation, may be made by those skilled in the art without departing from the spirit of the invention.

What I claim and desire to protect by Letters Patent is:

1. A composition for the treatment of natural fibers comprising:
a natural fiber washing composition comprising non-ionic surfactants and anionic surfactants in the ratio of about 3:1 and 1:3 respectively;
there being at least two nonionic surfactants having different molecular structures in said composition, each having a hydrophilic/lipophilic balance (HLB) value between about 0 and 20, and there being a difference in said HLB values of said nonionic surfactants in said composition of at least 2;
said nonionic surfactants being present in the ratio of about 1:2.

2. A composition for the treatment of natural fibers comprising:
a natural fiber rinsing composition comprising between about 1 and 3 percent by weight of at least one non-ionic surfactant and
between about 15 and 25 percent by weight of a cationic surfactant having the formula:
[R²(OR³)]_{y}[R⁴(OR³)_{y}]₂ R⁵ N⁺X⁻
wherein R² is an alkyl or alkyl benzyl group having from about 8 to about 18 carbon atoms in the alkyl chain,
each R³ is selected from the group consisting of —CH₂CH₂——, ——CH₂CN(CH₃)——, ——CH₂CH(CH₂OH)——, ——CH₂CH₂CH₂——, and mixtures thereof;
each R⁴ is selected from the group consisting of C₁-C₄ alkyl, C₁-C₄ hydroxyalkyl, benzyl ring structures formed by joining the two R⁴ groups, ——CH—CHOH——, CHOHCOR⁶CHOHCH₂0H wherein R⁶ is any hexose or hexose polymer having a molecular weight less than about 1000, and hydrogen when y is not 0:
R⁵ is the same as R⁴ or is an alkyl chain wherein the total number of carbon atoms of R² plus R⁵ is not more than about 18;
each y is from 0 to about 10 and the sum of the y values is from 0 to about 15: and X is any compatible anion.

3. The composition for the treatment of natural fibers as defined in claim 1 wherein a first nonionic surfactant in said composition has an HLB value in the range of between about 5 and 12 and a second anionic surfactant in said composition has an HLB value in the range of 12 to 16.

4. The composition for the treatment of natural fibers as defined in claim 3 wherein two nonionic surfactants are present, a first nonionic surfactant in said composition having an HLB value in the range of between about 8 and 11 and a second anionic surfactant in said composition having an HLB value in the range of between about 13 to 14.

5. The composition for the treatment of natural fibers as defined in claim 1 wherein said nonionic surfactant has the formula RO—(CH₂₋CH₂₋O)ₙH wherein R is a mixture of linear, even carbon number hydrocarbon chains ranging from C₁₂H₂₅ to C₁₆H₃₃ and n represents the number of repeating units and is a number from 1 to about 12; primary alkyl alcohols containing between about 12 and 16 carbon atoms condensed with about 2.5 to 16 moles of ethylene oxide; secondary alkyl alcohols containing between about 11 and 18 carbon atoms in a straight or branched chain configuration condensed with between about 5 to 30 moles of ethylene oxide; octylphenoxy polyethyoxyethanol; and said anionic surfactants are selected from the group selected from linear or branch C₁₀₋₁₆ alkyl benzene sulfonates, C₉ to C₁₆ alkyl ethoxy sulfates having 2.5 to 16 moles ethylene oxide, C₉ to C₁₆ alkyl alcohol sulfates potassium ammonium salts of alcohol sulfates, sodium ammonium salts of alcohol sulfates and sulfonates, C₉ to C₆ alcohol phosphates and phosphonates,
C₉ to C₁₆ alkyl sulfonates, C₉ to C₁₆ alkyl ethoxy sulfonates having 2.5 to 16 moles ethylene oxide, C3 to C6 alkylphenyl sulfonates, C₁₀₋₁₈ alkyl alkoxy carboxylates having 1 to 5 moles of ethylene oxide, and C₁₀₋₁₈ sarcosinates.

6. The composition for the treatment of natural fibers as defined in claim 2 wherein said nonionic surfactant is selected from the group consisting of a composition having the formula RO—(CH₂CH₂O)ₙH wherein R is a mixture of linear, even carbon number hydrocarbon chains ranging from C₁₂H₂₅ to C₁₆H₃₃ and n represents the number of repeating units and is a number from 1 to about 12; primary alkyl alcohols containing between about 12 and 16 carbon atoms condensed with about 2.5 to 16 moles of ethylene oxide; secondary alkyl alcohols containing between about 11 and 18 carbon atoms in a straight or branched chain configuration condensed with between about 5 to 30 moles of ethylene oxide; octylphenoxy polyethyoxyethanol; and said anionic surfactants are selected from the group selected from linear or branch C₁₀₋₁₆ alkyl benzene sulfonates, C₉ to C₁₆ alkyl ethoxy sulfates having 2.5 to 16 moles ethylene oxide, C₉ to C₁₆ alkyl alcohol sulfates potassium ammonium salts of alcohol sulfates, sodium ammonium salts of alcohol sulfates and sulfonates, C₉ to C₁₆ alcohol phosphates and phosphonates, C₉ to C₁₆ alkyl sulfonates, C₉ to C₁₆ alkyl ethoxy sulfonates having 2.5 to 16 moles ethylene oxide, C3 to C6 alkylphenyl sulfonates, C₁₀₋₁₈ alkyl alkoxy carboxylates having 1 to 5 moles of ethylene oxide, and C₁₀₋₁₈ sarcosinates.

7. The composition for the treatment of natural fibers as defined in claim 1 wherein said nonionic surfactants contain about 2.5 weight percent C₁₀ alkyl with 5 moles ethoxylated alcohol and about 5 weight percent C₁₂₋₁₅ alkyl with 7 moles ethoxylated alcohol and said anionic surfactant is about 22 weight percent C₁₀₋₁₈ linear alkyl benzene sulfate.

8. The composition for the treatment of natural fibers as defined in claim 1 wherein said nonionic surfactants contain about 7 weight percent C₁₀ alkyl with 5 moles ethoxylated alcohol and about 15 weight percent C₁₂₋₁₅ alkyl with 7 moles ethoxylated alcohol and said anionic surfactant is about 7 weight percent C₁₀₋₁₈ linear alkyl benzene sulfate.

9. The composition for the treatment of natural fibers as defined in claim 1 wherein said washing composition contains compatible additives to provide an anti-static, buffered pH effect are included with said surfactants in the blend along with water.

10. The composition for the treatment of natural fibers as defined in claim wherein said nonionic surfactant in said natural fiber rinsing composition has an HLB value in the range of between about 8 and 14.

11. A method for the washing and rinsing of natural fiber comprising:
washing said natural fiber by contacting said natural fiber with
a natural fiber washing composition comprising non-ionic surfactants and anionic surfactants in the ratio of about 3:1 and 1:3 respectively;
there being at least two nonionic surfactants having different molecular structures in said composition, each having a hydrophilic/lipophilic balance (HLB) value between about 0 and 20, there being a difference in said HLB values of said nonionic surfactants in said composition of at least 2;
said nonionic surfactants being present in the ratio of about 1:2 then
rinsing said washed natural fiber with a rinsing composition comprising
a natural fiber rinsing composition comprising between about 1 and 3 percent by weight of at least one non-ionic surfactant and between about 15 and 25 percent by weight of a cationic surfactant having the formula:
[R²(OR³)]_{y}[R⁴(OR³)_{y}]₂ R⁵ N⁺X⁻
wherein R² is an alkyl or alkyl benzyl group having from about 8 to about 18 carbon atoms in the alkyl chain,
each R³ is selected from the group consisting of —CH₂CH₂——, ——CH₂CH(CH₃)——, ——CH₂CH(CH₂OH)——, ——CH₂CH₂CH₂——, and mixtures thereof;
each R⁴ is selected from the group consisting of C₁-C₄ alkyl, C₁-C₄ hydroxyalkyl, benzyl ring structures formed by joining the two R⁴ groups, ——CH—CHOH——, CHOHCOR⁶CHOHCH₂OH wherein R⁶ is any hexose or hexose polymer having a molecular weight less than about 1000, and hydrogen when y is not 0:
R⁵ is the same as R⁴ or is an alkyl chain wherein the total number of carbon atoms of R² plus R⁵ is not more than about 18;
each y is from 0 to about 10 and the sum of the y values is from 0 to about 15: and X is any compatible anion.

12. The method for the washing and rinsing of natural fiber as defined in claim 11, wherein a first nonionic surfactant in said composition has an HLB value in the range of between about 5 and 12 and a second anionic surfactant in said composition has an HLB value in the range of 12 to 16.

13. The method for the washing and rinsing of natural fiber as defined in claim 12, wherein two nonionic surfactants are present, a first nonionic surfactant in said composition having an HLB value in the range of between about 8 and 11 and a second anionic surfactant in said composition having an HLB value in the range of 13 to 14.

14. The method for the washing and rinsing of natural fiber as defined in claim 11, wherein said washing nonionic surfactant has the formula RO—(CH₂₋CH₂₋O)ₙ—H wherein R is a mixture of linear, even carbon number hydrocarbon chains ranging from C₁₂H₂₅ to C₁₆H₃₃ and n represents the number of repeating units and is a number from 1 to about 12; primary alkyl alcohols containing between about 12 and 16 carbon atoms condensed with about 2.5 to 16 moles of ethylene oxide; secondary alkyl alcohols containing between about 11 and 18 carbon atoms in a straight or branched chain configuration condensed with between about 5 to 30 moles of ethylene oxide; octylphenoxy polyethyoxyethanol; and said anionic surfactants are selected from the group selected from linear or branch C₁₀₋₁₆ alkyl benzene sulfonates, C₉ to C₁₆ alkyl ethoxy sulfates having 2.5 to 16 moles ethylene oxide, C₉ to C₁₆ alkyl alcohol sulfates potassium ammonium salts of alcohol sulfates, sodium ammonium salts of alcohol sulfates and sulfonates, C₉ to C₁₆ alcohol phosphates and phosphonates, C₉ to C₁₆ alkyl sulfonates, C₉ to C₁₆ alkyl ethoxy sulfonates having 2.5 to 16 moles ethylene oxide, C3 to C6 alkylphenyl sulfonates, C₁₀₋₁₈ alkyl alkoxy carboxylates having 1 to 5 moles of ethylene oxide, and C₁₀₋₁₈ sarcosinates.

15. The method for the washing and rinsing of natural fiber as defined in claim 11, wherein said rinsing nonionic surfactant is selected from the group consisting of a composition having the formula RO—(CH₂₋CH₂₋O)ₙ—H wherein R is a mixture of linear, even carbon number hydrocarbon chains ranging from C₁₂H₂₅ to C₁₆H₃₃ and n represents the number of repeating units and is a number from 1 to about 12; primary alkyl alcohols containing between about 12 and 16 carbon atoms condensed with about 2.5 to 16 moles of ethylene oxide; secondary alkyl alcohols containing between about 11 and 18 carbon atoms in a straight or branched chain configuration condensed with between about 5 to 30 moles of ethylene oxide; octylphenoxy polyethyoxyethanol; and said anionic surfactants are selected from the group selected from linear or branch C₁₀₋₁₆ alkyl benzene sulfonates, C₉ to C₁₆ alkyl ethoxy sulfates having 2.5 to 16 moles ethylene oxide, C₉ to C₁₆ alkyl alcohol sulfates potassium ammonium salts of alcohol sulfates, sodium ammonium salts of alcohol sulfates and sulfonates, C₉ to C₁₆ alcohol phosphates and phosphonates, C₉ to C₁₆ alkyl sulfonates, C₉ to C₁₆ alkyl ethoxy sulfonates having 2.5 to 16 moles ethylene oxide, C3 to C6 alkylphenyl sulfonates, C₁₀₋₁₈ alkyl alkoxy carboxylates having 1 to 5 moles of ethylene oxide, and C₁₀₋₁₈ sarcosinates.

16. The method for the washing and rinsing of natural fiber as defined in claim 11, wherein said nonionic surfactants contain about 2.5 weight percent C₁₀ alkyl with 5 moles ethoxylated alcohol and about 5 weight percent C₁₂₋₁₅ alkyl with 7 moles ethoxylated alcohol and said anionic surfactant is about 22 weight percent C₁₀₋₁₈ linear alkyl benzene sulfate.

17. The method for the washing and rinsing of natural fiber as defined in claim 1, wherein said nonionic surfactants contain about 7 weight percent C₁₀ alkyl with 5 moles ethoxylated alcohol and about 15 weight percent C₁₂₋₁₅ alkyl with 7 moles ethoxylated alcohol and said anionic surfactant is about 7 weight percent C₁₀₋₁₈ linear alkyl benzene sulfate.

18. The method for the washing and rinsing of natural fiber as defined in claim 17, wherein said washing composition contains compatible additives to provide an anti-static, buffered pH effect which are included with said surfactants in the blend which blend is diluted with water to make a washing bath.

19. The method for the washing and rinsing of natural fiber as defined in claim 18, wherein said washing composition contains between about 0.1% and 0.8% of said surfactants in said water.

20. The method for the washing and rinsing of natural fiber as defined in claim 17, wherein said rinsing composition contains compatible additives to provide an anti-static, buffered pH effect which are included with said surfactants in the blend which blend is diluted with water to make a rinsing bath.

21. The method for the washing and rinsing of natural fiber as defined in claim 20, wherein said rinsing composition contains between about 0.1% and 0.8% of said surfactants in said water.
